(19) United States
(12) Patent Application Publication
(10) Pub. No.: US 2019/0013654 A1
(43) Pub. Date: Jan. 10, 2019

(54) WIRE HOUSING PROTECTOR

(71) Applicant: Sumitomo Wiring Systems, Ltd., Yokkaichi, Mie (JP)

(72) Inventor: Ryo SUENAGA, Yokkaichi, Mie (JP)

(73) Assignee: Sumitomo Wiring Systems, Ltd., Yokkaichi, Mie (JP)

(21) Appl. No.: 15/752,526

(22) PCT Filed: Aug. 24, 2015
(86) PCT No.: PCT/JP2015/073729

§ 371 Date: Feb. 13, 2018

(51) Int. Cl. H02G 3/04

(52) U.S. Cl. CPC H02G 3/0418; B60R 16/0215; H02G 3/0487

(57) ABSTRACT

A wire housing protector having a structure in which the volume of electric wires that can be accommodated can be increased by downsizing the locking mechanism, the workability at the time of assembly can be improved, and whether members in the locking mechanism are engaged properly can be more easily confirmed. A fitting protrusion that protrudes toward a lid side is provided at an upper surface of the side wall of the protector body in the vicinity of the elastic projecting piece insertion hole, and the lid is provided with a fitting protrusion housing hole that passes through the lid at a position corresponding to the fitting protrusion in plan view.

### TECHNICAL FIELD

The present invention relates to a wire housing protector for holding multiple electric wires laid therethrough that are routed inside an automobile or the like.

### BACKGROUND ART

Conventionally, in the electric system of automobiles or the like, multiple routed electric wires are laid through and held within a wire housing protector and secured at suitable locations in order to protect the electric wires from external members that might otherwise interfere with the electric wires and restrict the routing of the electric wires.

Incidentally, as described in JP H06-70415U (Patent Document 1) for example, such a wire housing protector is constituted by a trough-shaped protector body and a lid that covers the upper opening of the protector body. Once multiple electric wires are laid through the protector body, the lid is fixed to the protector body by a locking mechanism that protrudes from a sidewall of the protector body. In this way, the protector is capable of holding the multiple electric wires accommodated therein.

However, wire housing protectors having the foregoing conventional structure have an inherent problem in that, because the locking mechanism protrudes outward from a sidewall of the protector body, some of the capacity of the wire housing portion of the protector body is sacrificed so as to secure space for the locking mechanism. Especially in recent years, the demand for downsizing automobiles has been growing while the quantity of on-vehicle electrical equipment has also been increasing. Accordingly, there is a need to increase the housing space inside the protector body without enlarging the space necessary for mounting the wire housing protector. At times, conventionally structured wire housing protectors have been unable to meet this requirement sufficiently. In particular, there have been cases in which the lid could not easily interlock with the protector body because there were too many electric wires for the capacity of the wire housing protector.

Therefore, the applicant proposed, in JP 2014-82880A (Patent Document 2), a wire housing protector including a locking mechanism that is constituted by an elastic projecting piece that projects from an outer peripheral edge of a lid toward a protector body and an elastic projecting piece insertion hole that passes through the inside of a side wall of the protector body and opens in an upper surface, and in which an engagement protrusion provided at a leading end of the elastic projecting piece that has been inserted into the inside of the elastic projecting piece insertion hole engages with an engagement portion that projects from an inner surface of the elastic projecting piece insertion hole so as to prevent the lid from separating from the protector body. According to such a wire housing protector, because the locking mechanism is provided inside the side wall of the protector body, the side wall of the protector body can be extended to a maximum range of the space that is allowed to mount the wire housing protector, compared with a conventional structure in which the locking mechanism protrudes outward from the side wall of the protector body. Therefore, a dead space around the protector body that occurs due to the locking mechanism that protrudes outward from the side wall can be reduced, and the wire accommodating space in the protector body can be increased.

However, wire accommodation protectors having a structure in which the locking mechanism is provided inside the side wall of the protector body in this way suffer from an inherent problem. In particular, the opening area of the elastic projecting piece insertion hole that opens in the upper surface of the side wall of the protector body is inevitably made small, and the elastic projecting piece insertion hole is difficult to be located as well, and therefore the task of inserting the elastic projecting piece into the elastic projecting piece insertion hole is difficult. Furthermore, since the locking mechanism is constituted by the engagement protrusion formed at the leading end of the elastic projecting piece and the engagement portion formed inside the elastic projecting piece insertion hole, it is difficult to visually check the engagement state between the engagement protrusion and the engagement portion from the outside as well.

### SUMMARY

The present design has been made in view of the above-described circumstances and, as a solution to the problem, provides a wire housing protector having a new structure in which the volume of electric wires that can be accommodated can be increased by downsizing the locking mechanism, the workability at the time of assembly can be improved, and whether members in the locking mechanism are engaged properly can be more easily confirmed.

A first aspect of the design provides a wire housing protector including: a protector body extending in the shape of a trough; a lid for covering an upper opening of the protector body; and a locking mechanism for fixedly holding the protector body and the lid. The locking mechanism includes: an elastic projecting piece that protrudes from the lid and is provided with an engagement protrusion at an outer surface of its leading end; and an elastic projecting piece insertion hole that passes through the inside of a side wall of the protector body and opens in an upper surface of the side wall, and includes an engagement portion that engages with the engagement protrusion. When engagement protrusion of the elastic projecting piece that has been inserted into the elastic projecting piece insertion hole engages with the engagement portion, the lid is held by the protector body. The upper surface of the side wall of the protector body is provided with a fitting protrusion that protrudes toward the lid in the vicinity of the elastic projecting piece insertion hole, and the lid is provided with a fitting protrusion housing hole that passes through the lid at a position corresponding to the fitting protrusion in plan view.

According to the present aspect, because the locking mechanism is provided inside the side wall of the protector body and is designed to have a small size, the side wall of the protector body can be extended to a maximum range of the space that is allowed to mount the wire housing protector, compared with a conventional structure in which the locking mechanism protrudes outward from the side wall of the protector body, and the wire accommodating space in the protector body can be increased.

In addition, the fitting protrusion is provided at the upper surface of the side wall of the protector body in the vicinity of the elastic projecting piece insertion hole. Accordingly, when the elastic projecting piece provided in the lid is inserted into the elastic projecting piece insertion hole provided in the protector body from above, the elastic projecting piece can be positioned relative to the elastic projecting piece insertion hole using the fitting protrusion that protrudes from the upper surface of the protector body and is visually recognizable as a mark, and the workability at the time of assembly can be improved. Furthermore, because the lid is provided with the fitting protrusion housing hole that passes through the lid at a position corresponding to the fitting protrusion in plan view, the engagement state of the locking mechanism can be confirmed by visually checking the housing state of the fitting protrusion relative to the fitting protrusion housing hole. For example, if a top of the fitting protrusion is difficult to be seen from above the fitting protrusion housing hole, the locking mechanism can be confirmed to be in a state in which members in the locking mechanism are not properly engaged. In addition, as a result of inserting the fitting protrusion into the fitting protrusion housing hole, the lid can be prevented from rattling relative to the protector body.

A second aspect of the design provides the wire housing protector according to the first aspect, wherein, in a state in which the engagement protrusion and the engagement portion of the locking mechanism are properly engaged, a tip surface of the fitting protrusion is set to be flush with a lid upper surface in which the upper opening of the fitting protrusion housing hole opens.

According to the present aspect, because the tip surface of the fitting protrusion is set to be flush with the lid upper surface in which the upper opening of the fitting protrusion housing hole opens in a state in which the members in the locking mechanism are engaged properly, whether or not the tip surface of the fitting protrusion is flush with the lid upper surface at the periphery of the fitting protrusion housing hole can be further securely determined by checking visually or with tactile feeling from the outside. Accordingly, whether the lid is not properly assembled to the protector body can be further easily and securely determined. Furthermore, since the fitting protrusion does not protrude from the upper opening of the fitting protrusion housing hole, a problem such as the leading end of the fitting protrusion interfering with other members can be prevented from occurring.

A third aspect of the design provides the wire housing protector according to the first or second aspect, wherein a pair of the fitting protrusions are provided in the vicinity of the elastic projecting piece insertion hole on respective sides in a width direction, and the lid is provided with a pair of the fitting protrusion housing holes that pass through the lid at positions corresponding to the pair of fitting protrusions in plan view.

According to the present aspect, since the pair of fitting protrusions are provided in the vicinity of the elastic projecting piece insertion hole on respective sides in the width direction, the position of the elastic projecting piece insertion hole can be checked more easily, and the workability at the time of assembly can be further improved. Also, the lid can be more securely prevented from rattling relative to the protector body.

A fourth aspect of the design provides the wire housing protector according to any one of the first to third aspects, wherein the fitting protrusion is provided at a position that is separated from an outer surface of the side wall of the protector body.

According to the present aspect, since the fitting protrusion is provided at a position that is separated from the outer surface of the side wall of the protector body, the thickness of a wall portion on the outer peripheral edge side that defines the fitting protrusion housing hole of the lid can be sufficiently secured. Therefore, the fitting protrusion of the protector body that has been inserted into the fitting protrusion housing hole of the lid can be held with a sufficient strength.

A fifth aspect of the design provides the wire housing protector according to any one of the first to fourth aspects, wherein the fitting protrusion protrudes in a semicircular cross-sectional shape that protrudes toward the inside of the protector body.

According to the present aspect, the fitting protrusion protrudes in a semicircular cross-sectional shape that protrudes toward the inside of the protector body, and an outer surface of the fitting protrusion, which can be easily visually checked, extends in a plane that is parallel to the side wall of the protector body. Therefore, the visibility of the fitting protrusion as a mark and the guiding performance can be improved. Furthermore, since the fitting protrusion has an arc shape on the inner surface side, the stress received by a large plane on the outer surface side can be advantageously distributed, and therefore the fitting protrusion having rigidity that is sufficient to support the displacement load of the lid relative to the protector body can be advantageously formed at the upper surface of the narrow side wall of the protector body.

According to the wire housing protector of the present design, because the locking mechanism is provided inside the side wall of the protector body and is designed to have a small size, the side wall of the protector body can be extended to a maximum range of the space that is allowed to mount the wire housing protector compared with a conventional structure, and the wire accommodating space in the protector body can be increased. In addition, the fitting protrusion is provided at the upper surface of the side wall of the protector body in the vicinity of the elastic projecting piece insertion hole. Accordingly, when the elastic projecting piece of the lid is inserted into the elastic projecting piece insertion hole of the protector body from above, the elastic projecting piece can be positioned to the elastic projecting piece insertion hole using the fitting protrusion that is visually recognizable as a mark, and the workability at the time of assembly can be improved. Furthermore, because the lid is provided with the fitting protrusion housing hole that passes through the lid at a position corresponding to the fitting protrusion, the engagement state of the locking mechanism can be confirmed by visually checking the housing state of the fitting protrusion relative to the fitting protrusion housing hole. For example, if a top of the fitting protrusion is not easily seen from above the fitting protrusion housing hole, the locking mechanism is in a state in which the members in the locking mechanism are not properly engaged. Also, as a result of inserting the fitting protrusion into the fitting protrusion housing hole, the lid can be prevented from rattling relative to the protector body.

### BRIEF DESCRIPTION OF DRAWINGS

FIG. 1 is a general perspective view of a wire housing protector according to one embodiment.

FIG. 2 is an enlarged exploded perspective view of a locking mechanism of the wire housing protector shown in FIG. 1.

FIG. 3 is a plan view of the wire housing protector shown in FIG. 1.

FIG. 4 is an enlarged cross-sectional view taken along line IV-IV in FIG. 3.

FIG. 5 is an enlarged cross-sectional view taken along line V-V in FIG. 3.

### DESCRIPTION OF EMBODIMENTS

Hereinafter, embodiments of the present application will be described with reference to the drawings.

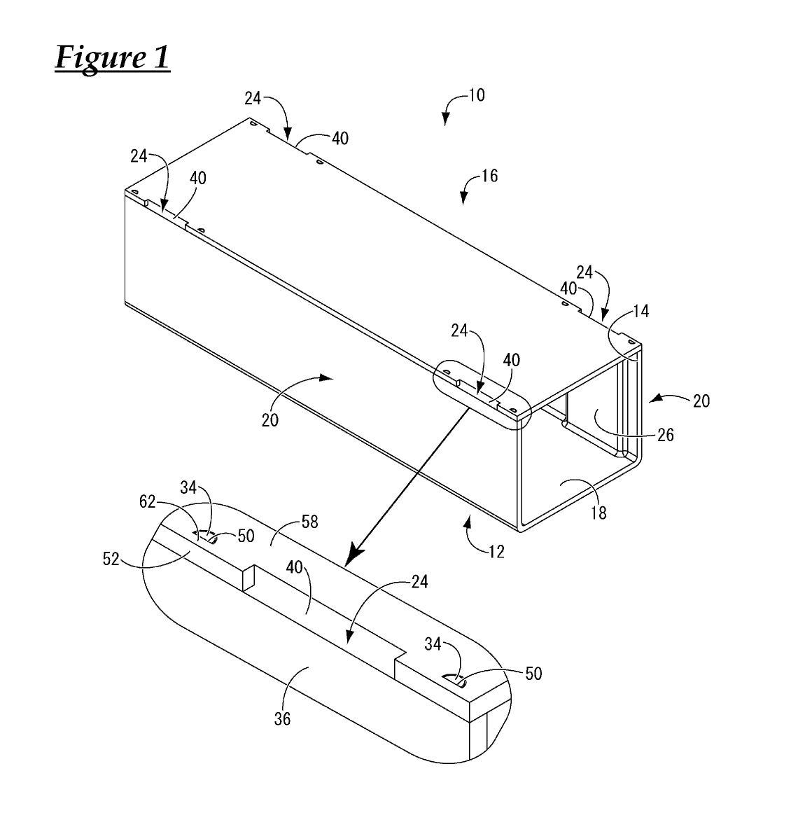

First, a wire housing protector 10 according to a first embodiment of the present invention is shown in FIGS. 1 to 5. The wire housing protector 10 is constituted by a protector body 12 extending in the shape of a trough and a lid 16 that covers the upper opening 14 of the protector body 12. When in use, the wire housing protector 10 accommodates a wire harness (not shown) laid through the protector body 12. Also, in the following description, “upward” refers to the upward direction in FIG. 1, “downward” refers to the downward direction in FIG. 1, “forward” refers to the leftward direction in FIG. 1, and “backward” refers to the rightward direction in FIG. 1.

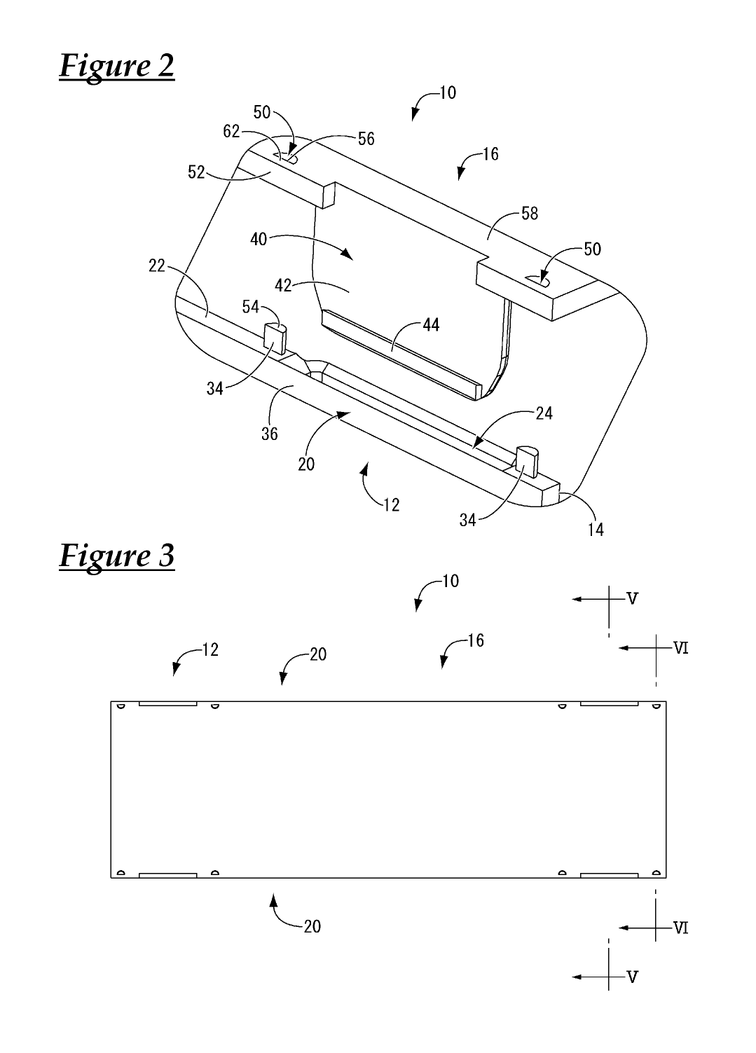

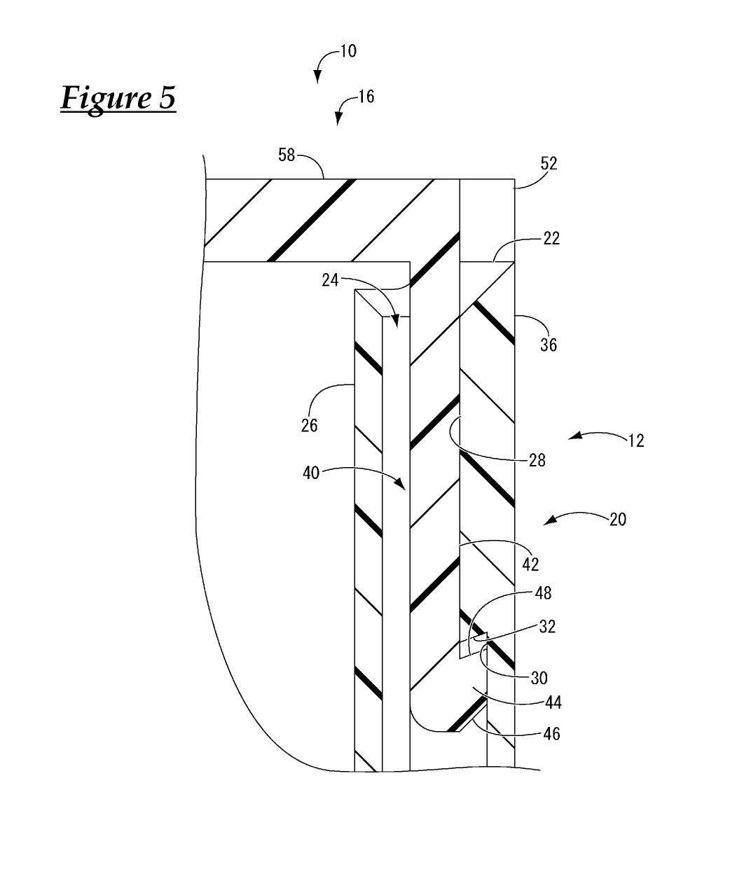

As shown in FIGS. 1 and 2, the protector body 12 is configured to extend in the shape of a trough, includes a bottom wall 18 and a pair of sidewalls 20 rising upright from both sides of the bottom wall 18, and is integrally formed of synthetic resin such as polypropylene (PP) or polyamide (PA), for example, by injection molding or the like. Also, in the side wall 20 of the protector body 12, elastic projecting piece insertion holes 24 that pass through the inside of the side wall 20 in a height direction and open in an upper surface 22 of the side wall 20 are provided. In the present embodiment, two elastic projecting piece insertion holes 24 are formed in each of a back side and a front side of the side wall 20, but any number of elastic projecting piece insertion holes 24 that are separated in a longitudinal direction (left-right direction in FIG. 1) may be provided as necessary. Here, an inner surface 26 of the side wall 20 where the elastic projecting piece insertion holes 24 are formed slightly protrudes toward the inside of the protector body 12. Furthermore, as shown in FIG. 5, an engagement portion 30 having a substantially recessed shape, which is formed by cutting out a portion, on a lower side, of an inner side 28 of the outer wall of the elastic projecting piece insertion hole 24, is provided in the elastic projecting piece insertion hole 24. An upper end surface 32 of the engagement portion 30 is a sloping surface that slopes obliquely downward toward the inside of the protector body 12. In addition, as shown in FIG. 2, in the upper surface 22 of the side wall 20 of the protector body 12, a pair of fitting protrusions 34 that protrude toward the lid 16 are provided in the vicinity of the elastic projecting piece insertion hole 24 on respective sides thereof in a width direction (left-right direction in FIG. 2). Specifically, the pair of fitting protrusions 34 are provided in positions that are separated from an outer surface 36 of the side wall 20 of the protector body 12, and protrude in a fixed semicircular cross-sectional shape that protrudes toward the inside of the protector body 12.

Meanwhile, as shown in FIGS. 1 and 2, the lid 16 is provided with, at its outer edge, a plurality of elastic projecting pieces 40 that each have a substantially rectangular shape, project toward the protector body 12, and are flexible in a plate thickness direction. The lid 16 is, similarly to the protector body 12, integrally formed of synthetic resin such as polypropylene (PP) or polyamide (PA), for example, by injection molding or the like, but is formed separately from the protector body 12. Note that, in the present embodiment, four elastic projecting pieces 40 are formed in correspondence with the elastic projecting piece insertion holes 24 described above. Also, an engagement protrusion 44 that protrudes outward in a plate thickness direction is provided at an outer surface 42 at a leading end of the elastic projecting piece 40. Specifically, as shown in FIG. 5, a lower end surface 46 of the engagement protrusion 44 is a tapered surface that slopes outward from a lower end side toward an upper end side in a direction in which the protector body 12 and the lid 16 are assembled. An upper end surface 48 of the engagement protrusion 44 is a sloping surface that slopes obliquely downward toward the inside of the protector body 12, similarly to the upper end surface 32 of the engagement portion 30 of the elastic projecting piece insertion hole 24.

In addition, as shown in FIG. 2, the lid 16 is provided with a pair of fitting protrusion housing holes 50 at positions corresponding to the pair of fitting protrusions 34 in plan view, that is, on both sides of a portion, in a width direction (left-right direction in FIG. 2), in which the elastic projecting piece 40 is provided. Specifically, the pair of fitting protrusion housing holes 50 are provided at positions that are separated from the outer peripheral surface 52 of the lid 16, and pass through the lid 16 in a fixed semicircular cross-sectional shape that protrudes toward the inside of the lid 16. Note that the fitting protrusion housing holes 50 have a shape that is similar to and slightly larger than the fitting protrusions 34 in plan view.

When the lid 16 is assembled to the protector body 12 of the wire housing protector 10 having the structure described above, first, the elastic projecting pieces 40 of the lid 16 are respectively inserted into the corresponding elastic projecting piece insertion holes 24 of the protector body 12. At this time, the lid 16 is assembled to the protector body 12 from above such that the pair of fitting protrusions 34 are fitted into the pair of fitting protrusion housing holes 50 that are provided in the lid 16, using the pair of fitting protrusions 34 that are provided at the upper surface 22 of the side wall 20 of the protector body 12 and are visually recognizable as a mark. Accordingly, the elastic projecting piece 40 can be easily inserted into the elastic projecting piece insertion hole 24 in a state in which the elastic projecting piece 40 is positioned relative to the elastic projecting piece insertion hole 24. Specifically, when the elastic projecting piece 40 is inserted into the elastic projecting piece insertion hole 24, since the lower end surface 46 of the engagement protrusion 44 of the elastic projecting piece 40 is a tapered sloping surface, the leading end of the elastic projecting piece 40 undergoes elastic deformation toward the inner surface of the protector body 12, and thus the elastic projecting piece 40 can be inserted into the elastic projecting piece insertion hole 24. Then, when the elastic projecting piece 40 is pushed even deeper into the elastic projecting piece insertion hole 24, and the engagement protrusion 44 formed at the leading end of the elastic projecting piece 40 passes over the upper end surface 32 of the engagement portion 30, the leading end of the elastic projecting piece 40 undergoes elastic restoration, and the engagement protrusion 44 engages with the engagement portion 30 of the elastic projecting piece insertion hole 24. Accordingly, the lid 16 is fixedly held by the protector body 12. As described above, in the present embodiment, the locking mechanism is constituted by the engagement portion 30 of the elastic projecting piece insertion hole 24 and the engagement protrusion 44 of the elastic projecting piece 40.

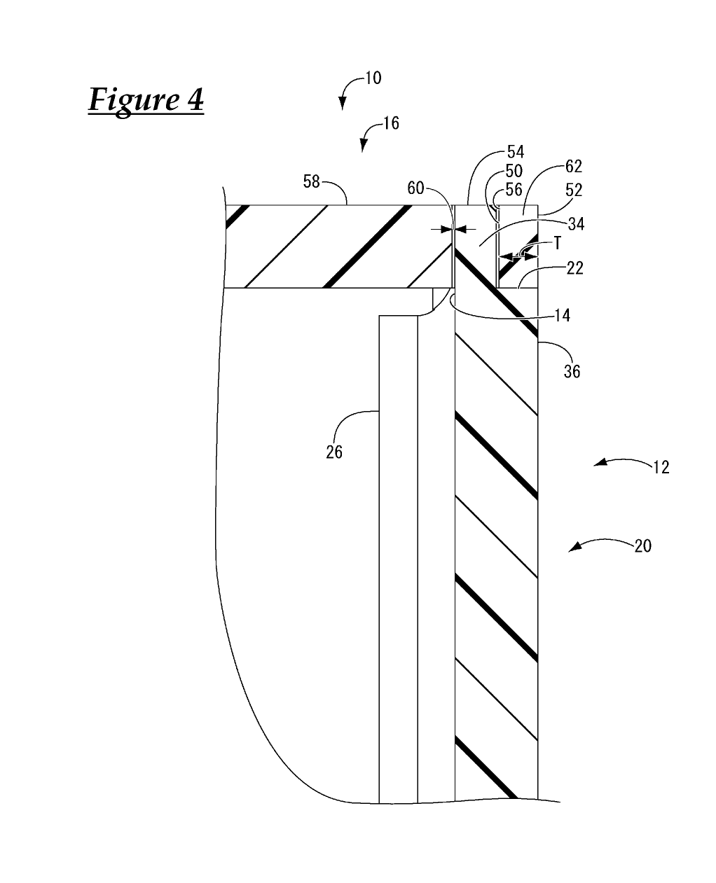

In the present embodiment, in a state in which the engagement portion 30 of the elastic projecting piece insertion hole 24 and the engagement protrusion 44 of the elastic projecting piece 40 that constitute the locking mechanism are properly engaged, the tip surfaces 54 of the fitting protrusions 34 are set to be flush with the lid upper surface 58 in which the upper openings 56 of the fitting protrusion housing holes 50 open, as shown in FIG. 4. Also, since the fitting protrusion housing holes 50 have a shape that is similar to and slightly larger than the fitting protrusions 34 in plan view, in a proper engagement state, the fitting protrusions 34 are loosely fitted into the respective fitting protrusion housing holes 50 across a small gap 60.

According to the wire housing protector 10 that is structured in this way, because the engagement portion 30 and the engagement protrusion 44 that constitute the locking mechanism are provided inside the side wall 20 of the protector body 12 and is designed to have a small size, the side wall 20 of the protector body 12 can be extended to a maximum range of the space afforded for mounting the wire housing protector, compared with a conventional structure, and the wire accommodating space in the protector body 12 can be increased.

Also, when the lid 16 is assembled to the protector body 12 of the wire housing protector 10, first, the lid 16 is assembled to the protector body 12 from above such that the pair of fitting protrusions 34 are fitted into the pair of fitting protrusion housing holes 50 that are provided in the lid 16 using the pair of fitting protrusions 34 that are provided at the upper surface 22 of the side wall 20 of the protector body 12 and are visually recognizable as a mark. Accordingly, the elastic projecting piece 40 can be easily inserted into the elastic projecting piece insertion hole 24 in a state in which the elastic projecting piece 40 is positioned relative to the elastic projecting piece insertion hole 24, and therefore the workability at the time of assembly can be improved.

Furthermore, in a proper engagement state, the tip surfaces 54 of the fitting protrusions 34 are set to be flush with the lid upper surface 58 in which the upper openings 56 of the fitting protrusion housing holes 50 open, and therefore whether the lid 16 is not properly assembled to the protector body 12 can be easily and securely determined by checking visually or by touch from the outside whether or not the tip surfaces 54 are flush with the lid upper surface 58. Furthermore, since the fitting protrusions 34 are configured to not protrude from the upper openings 56 of the respective fitting protrusion housing holes 50, a problem such as a leading end of the fitting protrusion 34 interfering with nearby other members, which are not illustrated, can be prevented from occurring. In addition, since the fitting protrusions 34 are inserted into the respective fitting protrusion housing holes 50, the lid 16 can be prevented from rattling relative to the protector body 12.

Also, the pair of fitting protrusions 34 provided in the vicinity of the elastic projecting piece insertion hole 24 and the corresponding pair of fitting protrusion housing holes 50 are provided, and as a result, the positioning of the elastic projecting piece 40 relative to the elastic projecting piece insertion hole 24 using the fitting protrusions 34 as a mark can be even more easily performed, the workability at the time of assembly can be further improved, and the lid 16 can be further securely prevented from rattling relative to the protector body 12.

Furthermore, since the fitting protrusions 34 protrude in a fixed semicircular cross-sectional shape that protrudes toward the inside of the protector body 12, an outer surface of each of the fitting protrusions 34, which can be easily visually checked, extends in a plane that is parallel to the side wall 20 of the protector body 12. Therefore, the visibility of the fitting protrusions 34 as a mark and the guiding performance can be improved. Furthermore, since each fitting protrusion 34 has an arc shape on the inner surface side, the stress received by a large plane on the outer surface side can be advantageously distributed, and therefore the fitting protrusions 34, which have sufficient rigidity to support the displacement load of the lid 16 relative to the protector body 12, can be advantageously formed at the upper surface 22 of the narrow side wall 20 of the protector body 12. In addition, since each fitting protrusion 34 is provided at a position that is separated from the outer surface 36 of the side wall 20 of the protector body 12, the thickness T (refer to FIG. 4) of a wall portion 62 on the outer peripheral edge side that defines the fitting protrusion housing hole 50 of the lid 16 can be sufficiently secured. Therefore, the fitting protrusions 34 of the protector body 12 that have been inserted into the respective fitting protrusion housing holes 50 of the lid 16 can be held with a sufficient strength.

Although embodiments of the present application have been described in detail above, the present invention is not limited by these specific descriptions. For example, although the pair of fitting protrusions 34 and the corresponding pair of fitting protrusion housing holes 50 are provided in the embodiment described above, the number thereof may be one or three or more. Also, the fitting protrusion 34 and the corresponding fitting protrusion housing hole 50 need not be provided in all the locking mechanisms. In addition, the fitting protrusion 34 and the corresponding fitting protrusion housing hole 50 have a semicircular cross-sectional shape in the above embodiment, but any shape such as rectangle or star can be adopted for the fitting protrusion 34 and the fitting protrusion housing hole 50. Also, the tip surface 54 of the fitting protrusion 34 need not be flush with the lid upper surface 58, and tip surface 54 may be set at a position that is slightly lower or higher than the lid upper surface 58 as long as the proper engagement can be confirmed.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10: Wire housing protector

12: Protector body

14: Upper opening

16: Lid

20: Side wall

22: Upper surface

24: Elastic projecting piece insertion hole (locking mechanism)

30: Engagement portion

34: Fitting protrusion

36: Outer surface

40: Elastic projecting piece (locking mechanism)

42: Outer surface

44: Engagement protrusion

50: Fitting protrusion housing hole

54: Tip surface

56: Upper opening

58: Lid upper surface

1. A wire housing protector comprising:
a protector body extending in the shape of a trough;
a lid for covering an upper opening of the protector body; and
a locking mechanism for fixedly holding the protector body and the lid,
wherein the locking mechanism includes:
an elastic projecting piece that protrudes from the lid and is provided with an engagement protrusion at an outer surface of its leading end; and
an elastic projecting piece insertion hole that passes through the inside of a side wall of the protector body and opens in an upper surface of the side wall, and includes an engagement portion that engages with the engagement protrusion,
wherein the wire housing protector is configured such that when the engagement protrusion of the elastic projecting piece that has been inserted into the elastic projecting piece insertion hole engages with the engagement portion, the lid is held by the protector body,
wherein the upper surface of the side wall of the protector body is provided with a fitting protrusion that protrudes toward the lid in the vicinity of the elastic projecting piece insertion hole, and
wherein the lid is provided with a fitting protrusion housing hole that passes through the lid at a position corresponding to the fitting protrusion in plan view.

2. The wire housing protector according to claim 1, wherein, in a state in which the engagement protrusion and the engagement portion of the locking mechanism are properly engaged, a tip surface of the fitting protrusion is flush with a lid upper surface in which the upper opening of the fitting protrusion housing hole opens.

3. The wire housing protector according to claim 1, wherein a pair of the fitting protrusions are provided in the vicinity of the elastic projecting piece insertion hole on respective sides in a width direction, and the lid is provided with a pair of the fitting protrusion housing holes that pass through the lid at positions corresponding to the pair of fitting protrusions in plan view.

4. The wire housing protector according to claim 1, wherein the fitting protrusion is provided at a position that is separated from an outer surface of the side wall of the protector body.

5. The wire housing protector according to claim 1, wherein the fitting protrusion protrudes in a semicircular cross-sectional shape that protrudes toward the inside of the protector body.
